(19) United States
(12) Patent Application Publication
(10) Pub. No.: US 2026/0230416 A1
(43) Pub. Date: Aug. 6, 2026

(54) ENHANCED DELAY INFORMATION REPORTING FOR EXTENDED REALITY (XR) COMMUNICATIONS

(71) Applicant: LENOVO (SINGAPORE) PTE. LTD., Singapore (SG)

(72) Inventors: Joachim LÖHR, Wiesbaden (DE); Prateek BASU MALLICK, Dreieich (DE); Shwetha SREEJITH, Homburg (DE); Hyung-Nam CHOI, Ottobrunn (DE)

(21) Appl. No.: 19/152,558

(22) PCT Filed: Apr. 23, 2024
(86) PCT No.: PCT/IB2024/053955

§ 371 Date: Jul. 31, 2025

Related U.S. Application Data
(60) Provisional application No. 63/499,859, filed on May 3, 2023.

(51) Int. Cl. H04L 43/0852; H04L 5/00; H04L 69/322

(52) U.S. Cl. CPC H04L 43/0852; H04L 5/0044; H04L 69/322

(57) ABSTRACT

Various aspects of the present disclosure relate to extended reality (XR) communications. For example, a user equipment (UE) may distinguish, or otherwise indicate, one or more reasons or conditions that trigger sending buffer status reports (BSRs) or delay status reports (DRSs). For example, the indication may include information that distinguishes a BSR or DSR as being triggered by new data arriving at and/or being received by a logical channel, by a delay status for data of the logical channel satisfying a predetermined condition or threshold, and so on. Further, the UE may introduce and/or utilize a trigger for BSR/DSR that is based on the delay information associated with data of a logical channel (LCH) or logical channel group (LCG).

### CROSS REFERENCE TO RELATED APPLICATIONS

This application claims priority to U.S. Provisional Patent Application No. 63/499,859, filed on May 3, 2023, entitled ENHANCED DELAY INFORMATION REPORTING FOR EXTENDED REALITY (XR) COMMUNICATIONS, which is hereby incorporated by reference in its entirety.

### TECHNICAL FIELD

The present disclosure relates to wireless communications, and more specifically to extended reality (XR) communications.

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Extended Reality, or XR, may refer to various types of realities, including virtual reality (VR), augmented reality (AR), mixed reality (MR), and so on. XR provides, for example, combinations of real and virtual environments via various interactions with machines, such as using wearable devices or other mobile or computing technologies.

### SUMMARY

The present disclosure relates to methods, apparatuses, and systems that support XR communications.

Some implementations of the method and apparatuses described herein may further include a UE comprising at least one memory and at least one processor coupled with the at least one memory and configured to cause the UE to receive, from a radio access network (RAN), a configuration for reporting delay information for data of a logical channel group (LCG), trigger a delay status report (DSR) when delay information associated with the data of the LCG satisfies a condition, and transmit the DSR in a physical uplink shared channel (PUSCH) transmission to the RAN.

In some implementations of the method and apparatuses described herein, the delay information comprises a remaining delay budget associated with the data of the LCG.

In some implementations of the method and apparatuses described herein, the delay information is associated with a packet data unit (PDU) set of the LCG.

In some implementations of the method and apparatuses described herein, the DSR is triggered in response to a remaining delay of a packet data unit (PDU) set of the LCG being under a configured threshold.

In some implementations of the method and apparatuses described herein, the DSR includes delay information and buffer size information for the LCG.

In some implementations of the method and apparatuses described herein, the DSR is part of a media access control (MAC) control element (CE).

In some implementations of the method and apparatuses described herein, the DSR includes, in the MAC CE, buffer size information that comprises an amount of data for all packet data convergence protocol (PDCP) packet data units (PDUs) or service data units (SDUs) of a PDU set of which at least one PDCP SDU has a remaining delay that is under a configured delay threshold.

In some implementations of the method and apparatuses described herein, a field or identifier of the MAC CE indicates a buffer status report (BSR) index associated with the delay information.

In some implementations of the method and apparatuses described herein, the delay information represents a shortest remaining value of a packet data convergence protocol (PDCP) discardTimer among PDCP service data units (SDUs) buffered for the LCG at a first symbol of a PUSCH transmission that includes the DSR.

In some implementations of the method and apparatuses described herein, the at least one processor is further configured to cause the UE to cancel the transmitted DSR when a MAC CE containing the DSR is included in the PUSCH transmission.

In some implementations of the method and apparatuses described herein, the configuration received from the RAN comprises a set of scheduling request configurations for the LCG, including: a first scheduling request configuration associated with triggering the DSR when new data arrives to the LCG, and a second scheduling request configuration associated with triggering the DSR when the delay information associated with the data of the LCG satisfies the condition.

Some implementations of the method and apparatuses described herein may further include a method performed by a UE, the method comprising receiving, from a RAN, a configuration for reporting delay information for data of an LCG, triggering a DSR when delay information associated with the data of the LCG satisfies a condition, and transmitting the DSR in a PUSCH transmission to the RAN.

In some implementations of the method and apparatuses described herein, the configuration received from the RAN comprises a set of scheduling request configurations for the LCG, including a first scheduling request configuration associated with triggering the DSR when new data arrives to the LCG and a second scheduling request configuration associated with triggering the DSR when the delay information associated with the data of the LCG satisfies the condition.

In some implementations of the method and apparatuses described herein, the delay information comprises a remaining PDU delay budget for the LCG.

In some implementations of the method and apparatuses described herein, the delay information is associated with a PDU set of the LCG.

In some implementations of the method and apparatuses described herein, the DSR is triggered in response to a remaining delay of a PDU set of the LCG being under a configured threshold.

Some implementations of the method and apparatuses described herein may further include a processor for wireless communication, the processor comprising at least one controller coupled with at least one memory and configured to cause the processor to receive, from a RAN, a configuration for reporting delay information for data of an LCG, trigger a DSR when delay information associated with the data of the LCG satisfies a condition, and transmit the DSR in a PUSCH transmission to the RAN.

Some implementations of the method and apparatuses described herein may further include a UE, comprising at least one memory and at least one processor coupled with the at least one memory and configured to cause the UE to determine that new data has arrived to one or more LCGs associated with the UE and transmit a BSR MAC CE that comprises buffer size fields, wherein each buffer size field indicates a buffer size value using a BSR table for each LCG of the one or more LCGs.

In some implementations of the method and apparatuses described herein, at least one BSR table indicates a data volume for the data of the one or more LCGs.

In some implementations of the method and apparatuses described herein, the BSR MAC CE is identified by a logical channel ID (LCH ID) reserved for the BSR MAC CE.

### BRIEF DESCRIPTION OF THE DRAWINGS

FIG. 1 illustrates an example of a wireless communications system that supports XR communications in accordance with aspects of the present disclosure.

FIG. 2 illustrates an example of a block diagram that depicts communications between the UE and the network entity in accordance with aspects of the present disclosure.

FIG. 3 illustrates an example of a block diagram of a device that supports XR communications in accordance with aspects of the present disclosure.

FIG. 4 illustrates a flowchart of a method that supports transmitting a scheduling request based on an applied configuration in accordance with aspects of the present disclosure.

FIG. 5 illustrates a flowchart of a method that supports transmitting a BSR in accordance with aspects of the present disclosure.

### DETAILED DESCRIPTION

To facilitate efficient delay-aware scheduling of XR services with tight delay requirements, a UE may provide delay information associated with packet data units (PDUs) and/or PDU sets to a gNB (e.g., by reporting delay information within a buffer status report (BSR) or delay status report (DSR) media access control control element, or MAC CE). For example, during a BSR or DSR procedure, a UE may trigger a BSR or DSR based on the arrival of data (e.g., high priority data).

However, the gNB may not be aware that data within the UE (e.g., within a buffer of the UE) is close to an associated delay budget (e.g., may soon exceed a packet set delay budget, or PSDB). Further, even when additional BSR triggers based on delays are utilized, the gNB may not be able to determine whether a status report was triggered due to data arrival, delays, or other factors.

The technology described herein solves such problems by providing information (e.g., a delay status report, or DSR) regarding a delay status of data within the UE, such as XR data, in a timely manner to the gNB or other network entity. The UE may distinguish, or otherwise indicate, one or more reasons or conditions that triggered sending of a buffer status report or reports. For example, the indication may include information that distinguishes a BSR as being triggered by new data arriving at and/or being received by a logical channel, by a delay status for data of the logical channel satisfying a predetermined condition or threshold, and so on. Further, the UE may introduce and/or utilize a trigger for BSR that is based on the delay information associated with data of a logical channel (LCH) or logical channel group (LCG).

Thus, in some embodiments, a UE may employ new or enhanced reporting triggers and/or enable a scheduler in a gNB to distinguish scheduling request(s) for triggered BSRs/DSRs (e.g., based on data arrival) and delay triggered BSRs/DSRs via a mapping between LCHs and status report (SR) configurations.

The technology, therefore, may differentiate SRs triggered by data arrival and SRs triggered by delay statuses of data within a UE. For example, one LCH may be mapped to more than one SR configuration, such as a first SR configuration for data arrival triggered BSRs and a second SR configuration for delay triggered BSRs/DSRs. Thus, the technology may ensure that a gNB, or other network entity, is made aware of a critical delay status in the UE in a timely manner, among other benefits.

Aspects of the present disclosure are described in the context of a wireless communications system. Aspects of the present disclosure are further illustrated and described with reference to device diagrams and flowcharts.

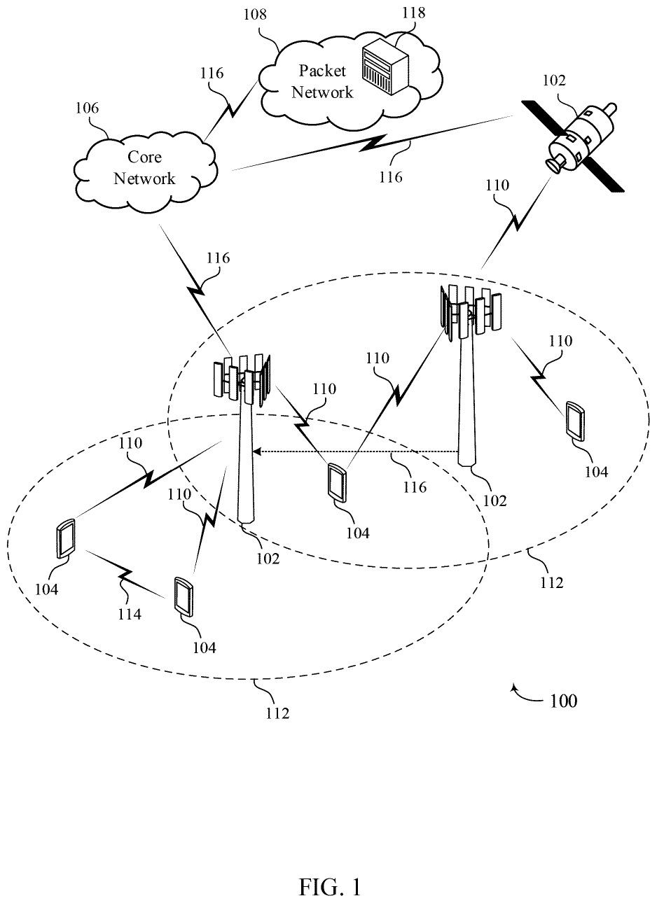

FIG. 1 illustrates an example of a wireless communications system 100 that supports XR communications in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling and may each be at least partially controlled by the CU 160.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers)) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. #Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHz-24.25 GHz), FR4 (52.6 GHZ-114.25 GHZ), FR4a or FR4-1 (52.6 GHZ-71 GHz), and FR5 (114.25 GHZ-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

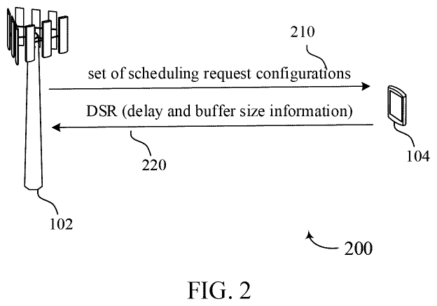

As described herein, in some embodiments, the UE 104 can send BSRs to the network entity 102 based on status report configurations that map to the conditions that triggered the BSRs. FIG. 2 illustrates an example of a block diagram that depicts communications between the UE 104 and the network entity 102 in accordance with aspects of the present disclosure.

As shown, the network entity 102 (e.g., the gNB) configures one SR configuration for a logical channel, which indicates to the network that the delay information associated with data of the logical channel has satisfied a predefined criterion/condition (e.g., a set of scheduling request configurations 310). In some cases, an LCH can be mapped to more than one SR configuration, such as a set of configurations.

The UE 104 can utilize a new or enhanced trigger for buffer status reporting, based on the delay information associated with an LCH or LCG, by triggering BSR/DSR when the delay information of the data of a LCH satisfies a predefined criterion, condition, and/or threshold. For example, the UE/MAC triggers a regular BSR when a BSR has been triggered based on the delay information associated with the data of an LCH/LCG satisfying a predefined condition, and transmits the BSR (e.g., via a DSR 220) to the NE 102.

In some embodiments, a new trigger for buffer status reporting (BSR) is introduced based on the delay information associated with data of an LCH or LCG. For example, a BSR is triggered for cases when the delay information satisfies a predefined criterion. The criterion for BSR may include:
A remaining delay budget (RDB) or remaining PDU-set delay budget (RPSDB) associated with data/PDU set of a logical channel/LCG is below a predefined/preconfigured threshold;
An amount of data of an LCH/LCG for which the remaining delay budget (RDB) or remaining PDU-set delay budget (RPSDB) is below a predefined threshold is exceeding a predefined second threshold;
A remaining delay budget (RDB) or remaining PDU-set delay budget (RPSDB) associated with data/PDU set of a logical channel/LCG is zero, e.g. delay budget or PSDB is exceeded;
An amount of time data/PDU set of a LCH is stored in the buffer being available for transmission is exceeding a threshold;
The discard timer value of a PDU/PDU set is below a predefined threshold; and so on.

In some cases, a new trigger for BSR is introduced based on the delay information. For example, regular BSR is triggered if a BSR has been triggered based on the delay information associated with data of a LCH/LCG satisfying a predefined condition.

An example implementation is as follows:
A BSR shall be triggered if any of the following events occur for activated cell group:
   UL data, for a logical channel which belongs to an LCG, becomes available to the MAC entity; and either
   this UL data belongs to a logical channel with higher priority than the priority of any logical channel containing available UL data which belong to any LCG; or
   none of the logical channels which belong to an LCG contains any available UL data.
   delay information associated with UL data/PDU set being available for transmission is below PSDB threshold
   in which case the BSR is referred below to as ‘Regular BSR’;
   UL resources are allocated and number of padding bits is equal to or larger than the size of the Buffer Status Report MAC CE plus its subheader, in which case the BSR is referred below to as ‘Padding BSR’;
   retxBSR-Timer expires, and at least one of the logical channels which belong to an LCG contains UL data, in which case the BSR is referred below to as ‘Regular BSR’;
   periodicBSR-Timer expires, in which case the BSR is referred below to as ‘Periodic BSR’.

In some embodiments, the delay information reported in a MAC control element (e.g., a BSR MAC CE) may reflect the status of the delay information at a time or first instance of the transmission of the MAC CE that contains the delay information on a PUSCH resource. For example, the UE 104 determines/calculates the delay information, which is reported in a MAC CE for the slot/symbols (e.g., first symbol of the slot), where the MAC CE is transmitted on a PUSCH resource. In one example, the delay information contained in a MAC CE reflects the remaining delay budget/remaining PSDB at the time where the MAC CE is transmitted on PUSCH.

When the MAC CE cannot be transmitted (e.g., due to prioritization or listen before talk (LBT) failure), the UE 104 may recalculate the delay information at the time when the MAC CE is (re) transmitted. For example, the recalculation of the delay information is only done for an initial Hybrid ARQ (Automatic Repeat reQuest), or HARQ, transmission (not for HARQ retransmission).

In some embodiments, the NE 102 configures one SR configuration for a logical channel which indicates to the NE 102 that the delay information associated with data of this logical channel has satisfied a predefined criterion/condition. In some cases, a separate dedicated SR configuration is used by the UE 104 when a LCH triggered a BSR due to delay information associated with data of the LCH satisfying a predefined criterion/condition. The UE 104 may use a first SR configuration for cases that a LCH triggered a BSR (e.g., due to high priority data arrival), and a second SR configuration for cases that the delay information of the data of the LCH triggered a BSR. In some cases, one LCH channel can be only mapped to one SR configuration.

In some cases, a LCH can be mapped to more than one SR configuration. For example, one SR configuration may be used for cases when BSR was triggered due to data arrival and another SR configuration may be used when BSR has been triggered when a condition is satisfied (e.g., the remaining delay budget or remaining PSDB is below a predefined threshold). By mapping a LCH to multiple SR configurations (e.g., within the set of configurations 310), SR resources (e.g., PUCCH resources) can indicate to the NE 1902 why the BSR was triggered (e.g., data arrival or delay status of the data satisfying a condition). Via this early indication (e.g., by dedicated SR), the NE 102 (e.g., a gNB) may quickly react and issue an appropriate UL grant. For example, the LogicalChannelConfig 1E contains a new field that indicates the scheduling request configuration applicable for the corresponding logical channel for cases when the BSR was triggered due to the delay status of the data of the LCH satisfying a predefined condition.

An example implementation is as follows:

| | |
|---|---|
| LogicalChannelConfig ::= | SEQUENCE { |
| ul-SpecificParameters | SEQUENCE { |
| priority | INTEGER (1..16), |
| prioritisedBitRate | ENUMERATED {kBps0, kBps8, kBps16, kBps32, |

kBps64, kBps128, kBps256, kBps512,

kBps1024, kBps2048, kBps4096, kBps8192, kBps16384,

kBps32768, kBps65536, infinity},

| | |
|---|---|
| bucketSizeDuration | ENUMERATED {ms5, ms10, ms20, ms50, ms100, |

ms150, ms300, ms500, ms1000,

| | |
|---|---|
| | spare7, spare6, spare5, spare4, spare3, spare2, spare1}, |
| allowedServingCells | SEQUENCE (SIZE (1..maxNrofServingCells-1)) OF |

ServCellIndex

OPTIONAL, -- Cond

PDCP-CADuplication

| | |
|---|---|
| allowedSCS-List | SEQUENCE (SIZE (1..maxSCSs)) OF |
| SubcarrierSpacing | OPTIONAL, -- Need R |
| maxPUSCH-Duration | ENUMERATED {ms0p02, ms0p04, ms0p0625, |

ms0p125, ms0p25, ms0p5, ms0p01-v1700, spare1}

OPTIONAL, -- Need

R

| | |
|---|---|
| configuredGrantType1Allowed | ENUMERATED {true} |

OPTIONAL, -- Need R

| | |
|---|---|
| logicalChannelGroup | INTEGER (0..maxLCG-ID) |

OPTIONAL, -- Need R

| | |
|---|---|
| schedulingRequestID | SchedulingRequestId |

OPTIONAL, -- Need R

| | |
|---|---|
| schedulingRequestdelayID | SchedulingRequestId |

OPTIONAL, -- Need R

| | |
|---|---|
| logicalChannelSR-Mask | BOOLEAN, |

```
    logicalChannelSR-DelayTimerApplied BOOLEAN,
    ...,
    bitRateQueryProhibitTimer ENUMERATED {s0, s0dot4, s0dot8, s1dot6, s3, s6,
```

| | |
|---|---|
| s12, s30} | OPTIONAL, -- Need R |

[[

| | |
|---|---|
| allowedCG-List-r16 | SEQUENCE (SIZE (0.. |

maxNrofConfiguredGrantConfigMAC-1-r16)) OF ConfiguredGrantConfigIndexMAC-r16

OPTIONAL, --

```
Need S
    allowedPHY-PriorityIndex-r16 ENUMERATED {p0, p1}
OPTIONAL -- Need S
    ]],
    [[
    logicalChannelGroupIAB-Ext-r17 INTEGER (0..maxLCG-ID-IAB-r17)
OPTIONAL, -- Need R
```

| | |
|---|---|
| allowedHARQ-mode-r17 | ENUMERATED {harqModeA, harqModeB} |

OPTIONAL -- Need R
]]

| | |
|---|---|
| } | OPTIONAL, -- Cond |

```
UL
  ...,
  [[
```

| | |
|---|---|
| channelAccessPriority-r16 | INTEGER (1..4) |

OPTIONAL, -- Need R

| | |
|---|---|
| bitRateMultiplier-r16 | ENUMERATED {x40, x70, x100, x200} |

OPTIONAL -- Need R
]]
}
-- TAG-LOGICALCHANNELCONFIG-STOP
-- ASN1STOP

In one example, one SR configuration is configured for a LCH, which is used for cases when BSR is triggered due to data arrival (e.g., during legacy trigger conditions), another SR configuration for cases when the BSR has been triggered due to delay status of data of the LCH satisfying a predefined condition (e.g., a delay based BSR trigger), and a third SR configuration for cases when the BSR has been triggered due to data arrival and the delay status of the data satisfying a predefined condition.

In some cases, one SR configuration is used by the UE/MAC entity for cases when a BSR was triggered due to a delay status of data in the UE satisfying a predefined condition. Regardless of the LCH for which the delay BSR was triggered, the MAC entity uses only one SR configuration in order to notify the NE 102 that there is data in the UE 104 for which the remaining delay budget or remaining PSDB is below a certain threshold (e.g., data is close to exceeding the delay budget).

In some embodiments, the delay information reported for a LCH or LCG includes a smallest remaining delay budget or remaining PSDB of the data of the LCH or among the LCHs within a LCG being available for transmission. For example, the UE 104 reports the delay information (e.g., a smallest remaining delay budget or remaining PDSB), and the amount of data associated with the reported delay information (e.g., the remaining PDUs of a PDU sets available for transmission for which the remaining PSDB is reported).

In some embodiments, the delay information is reported on a PDU set level. For example, the UE 104 reports the delay information (e.g., the smallest remaining delay budget or remaining PDSB), and the amount of data for the PDU set for which the delay information is reported (e.g., the remaining amount of data for the PDU set for which the remaining delay budget or remaining PSDB triggered a BSR). The remaining delay budget or remaining PSDB may be determined based on the lowest RDB of a PDU belonging to a PDU set. When the UE 104 starts and maintains a PDCP discard timer for every PDCP SDU (e.g., during legacy operation) the discard timer value for different PDCP SDUs belonging to the same PDU set may have different values (e.g. the discard timer of the first PDCP SDU of the PDU set that arrived from higher layer in the PDCP entity may have the lowest value (since it was started first)). Thus, the remaining delay budget or remaining PSDB of a PDU set is determined based on the lowest remaining packet delay budget of the PDCP SDUs belonging to the PDU set. Generally, the discard timer value for the remaining packet delay budget of the first PDCP SDU/PDU of a PDU set determines the remaining PSDB of the whole PDU set.

In some cases, the UE 104 may report the amount of data of all the PDCP SDU/PDUs of a PDU set being available for transmission even if the remaining delay budget of only one of the PDCP PDUs/SDUs belonging to the PDU set is below a predefined threshold.

In some embodiments, the UE 104 or MAC entity considers that the logical channel that triggered the BSR is the LCH that has the smallest remaining delay budget or smallest remaining PSDB, such as when the BSR was triggered by retxBSR-Timer expiry. The MAC entity may consider the highest priority LCH having data available for transmission as the LCH that triggered the BSR for BSR triggered by retxBSR-Timer expiry as follows:

For BSR triggered by retxBSR-Timer expiry, the MAC entity considers that the logical channel that triggered the BSR is the highest priority logical channel that has data available for transmission at the time the BSR is triggered.

When the remaining delay budget is above a threshold, the UE/MAC entity considers (e.g., during legacy operations), the highest priority LCH as the LCH that triggered the BSR. However, when the remaining delay budget or remaining PSDB is below or equal to the threshold, the UE/MAC considers the LCH with the smallest remaining delay budget as the LCH that triggered the BSR.

In some embodiments, a pending delay-triggered BSR (e.g., BSR triggered due to the delay status of data in the UE/MAC satisfying a predefined condition), may be canceled when a MAC PDU is transmitted and the PDU includes a BSR MAC CE that contains the delay information for the LCH/LCG that triggered the delay-triggered BSR. An example implementation is as follows:

All triggered BSRs may be canceled when the UL grant(s) can accommodate all pending data available for transmission but is not sufficient to additionally accommodate the BSR MAC CE plus its subheader. All BSRs triggered prior to MAC PDU assembly shall be cancelled when a MAC PDU is transmitted and this PDU includes a Long, Extended Long, Short, or Extended Short BSR MAC CE which contains buffer status up to (and including) the last event that triggered a BSR prior to the MAC PDU assembly.

In some embodiments, a BSR MAC CE contains the buffer status information and associated delay information for the LCH/LCG with the lowest remaining delay budget or lowest remaining PDSB. In some cases, the BSR MAC CE is a short BSR MAC CE or a short truncated BSR MAC CE.

Generally, the UE 104 reports the LCG with the highest priority data available for transmission (e.g., via a short BSR MAC CE). However, the UE 104 may provide information to the gNB on the LCG with the lowest remaining PSDB or in more general with the most critical delay status when providing a short BSR. For example, the NE 102 configures the UE 104 whether to provide high priority information or delay critical information within a short or short truncated BSR. The configuration may be per LCG. In The UE 104 may determine, based on some comparison of the lowest remaining delay budget or PSDB of the data available for transmission against a threshold, whether to include the highest priority data/LCG in a short BSR or the LCG with the most critical delay status.

In some embodiments, the NE 102 configures whether the UE/MAC may report delay information for a LCG or LCH. For example, the NE 102 configures whether the UE 104 includes delay status information of the data for an LCG/LCH within a BSR. The NNE 102 may configure, within the logicalchannelconfig-IE, whether delay status information is to be reported to the NE 102 (e.g., within a BSR MAC CE). In some cases, the delay information may be requested for LCH(s)/LCG(s) which carry specific XR-traffic.

In some embodiments, the NE 102 configures whether the UE/MAC is to trigger a BSR due to the delay status of data satisfying a predefined condition/criterion. For example, the configuration is done for each LCH (e.g., a logicalchannelconfig-IE contains some configuration (new parameter) that indicates whether the UE 104 is to apply BSR triggering based on some predefined delay status conditions). In some cases, the configuration is done on a MAC level. For example, the NE 102 configures for a MAC entity whether the UE 104 triggers a BSR due to the delay status of data satisfying a predefined condition/criterion.

In some embodiments, the UE/MAC considers the LCP restrictions as not being met when a BSR has been triggered due to the delay status of data satisfying some predefined condition and the UE 104 has UL-SCH resources available for a new transmission. The UE 104 may trigger a SR for a delay-triggered BSR even when the UE 104 has some UL-SCH resources available for a new transmission. In some cases, the UE 104 triggers an SR if the UL-SCH resources for a new transmission are too far in the future such that the remaining delay budget or remaining PSDB is less than the time until the UL-SCH resource allocation. In some cases, a threshold is configured (e.g., if the available UL-SCH resources are occurring in a slot which is farther away than the threshold), and the UE 104 triggers an SR.

In some embodiments, the UE/MAC entity triggers a BSR when a set of predefined LCG(s) has no (more) data available for transmission (e.g., has a zero buffer size). For example, the MAC triggers a BSR in order to inform the gNB that there is no data available for transmission for a configured set of LCH(s). The trigger may ensure that a gNB is made aware of the end of a data burst (e.g., XR-traffic or another video stream). In some cases, the MAC entity triggers a BSR when the transmission buffer of a preconfigured LCH or LCG is empty (e.g., after the UE 104 transmitted the last data in the buffer for the LCH/LCG).

In some cases, the UE 104 includes a BSR MAC CE indicating a zero-byte BS for the LCH/LCG in the last TB of a data burst for the LCH/LCG.

In some embodiments, the UE 104 indicates within the CG-UCI the end of a data burst (EOB). For example, the CG-UCI or more in general uplink control indication (UCI) indicates the CG PUSCH occasion, which includes the last data of a data burst (e.g., EOB). Thus, the CG-UCI indicates unused CG PUSCH resources/occasions in order to allow the gNB to reallocate those resources (e.g., to other UEs) and includes the end of burst (EOB) indication.

In some embodiments, the UE 104 includes, within the delay information reported to the gNB for a LCH or LCG (e.g., within a BSR MAC CE), delay information with respect to other inter-dependent LCH(s)/LCG(s). For example, use cases such as AR/VR and holographic communications encompass multiple simultaneous traffic flows, where the arrival of packets is to be synchronized.

For multi-modal services like tactile/haptic communications, this includes different types of streams (e.g., corresponding to different human senses). Incorporating the five senses in the XR experience necessitates more stringent end-to-end latency, jitter, and synchronization. Such services may have even more stringent requirements on a wireless network since holographic flows may require very tight synchronization of the five senses. For XR applications transmitted via a wireless communications system, interactions between different input signals can be translated to some inter-dependencies between transmissions of different flows. 3GPP is discussing solutions which allow to efficiently support multi-modal XR applications.

These associated flows are inter-dependent and need to be handled together. In order to allow coordinated transmission for associated flows to ensure synchronized delivery, there may be a maximum tolerable delay difference for a group of associated flows. For example, the delay information may include a remaining maximum tolerable delay difference for a group of associated or inter-dependent LCH(s) or LCG(s). When LCH1 is associated with LCH2, the delay information for LCH1, which is reported to the gNB (e.g., within a BSR MAC CE) may contain the remaining PSDB for data of LCH1 and the remaining maximum tolerable delay difference to LCH2. In some cases, the remaining maximum tolerable delay difference is the smallest remaining maximum tolerable delay difference among the data in the associated LCHs/LCGs.

In some embodiments, a BSR MAC control element is comprised of buffer size fields, such as for LCGs, indicating buffer size values using a first BSR table and buffer size fields indicating buffer size values using a second BSR table. The BSR MAC CE may include different BSR tables used to indicate the data volumes of different LCGs. In one example, a first set of buffer sizes for a first set of LCGs may utilize an XR-specific BSR table, where the quantization error is minimized for typical XR data volumes, and a second set of buffer sizes for a second set of LCGs may utilize legacy BSR tables (e.g., defined in the current specifications (TS38.321)).

In one example, the BSR MAC CE contains an identifier for each buffer size field included in the BSR MAC CE, which identifies the BSR table used for indicating the data volume. The identifier field may indicate the BSR table used for the data volume indication and/or may indicate whether delay information is included in the BSR MAC CE for the buffer size for the LCG.

The BSR MAC CE, which may be identified by a new reserved logical channel identifier (LCH ID) includes buffer status information (optionally with delay information) for XR-traffic as well as buffer status information for legacy traffic. The BSR MAC CE may have or include different BS formats. In order for a gNB to decode and parse received BSR information, the BSR MAC CE may contain identifiers indicating the different formats. For example, the LCG ID field identifying the group of logical channels whose buffer status/delay information is being reported implicitly indicates the BS format e.g., indicates the BSR table used for the buffer status and/or indicates whether delay information is being included for the LCG).

In some embodiments, a UE access stratum (AS) layer informs the application layer about discarding of packets (e.g., PDCP PDUs/SDUs), which are not used for a correct decoding of the corresponding PDU set/application data unit. When using forward error correction on application layer (AL-FEC), the application only receives a sufficient number of PDUs of a PDU Set to complete its decoding. Thus, it may not receive all of the PDUs of a PDU set for a correct decoding due to AL-FEC.

However, when simply discarding unnecessary redundant PDUs of a PDU set, which are not used for a correct decoding, the adaptation algorithm in the AL may assume that there is an increase in the end-to-end loss rate and thus increases its code rate because codecs using AL-FEC typically adapts its FEC code rate based on measured loss rate. This may lead to an over protection and drop of the capacity by delivering redundant PDUs.

Therefore, in some cases, the AS of the UE (e.g., PDCP layer) indicates to the AL that PDUs where dropped, and hence the increase of the PDU loss rate was due to the discarding of unnecessary or redundant PDUs (e.g., PDUs not used for a correct decoding). The UE 104 may provide to the gNB a new indication indicating that PDUs were dropped due to AL-FEC. The UE 104 may indicate within the CG-UCI an “unused resource” indication of CG PUSCH resources that unused due to AL-FEC dropping.

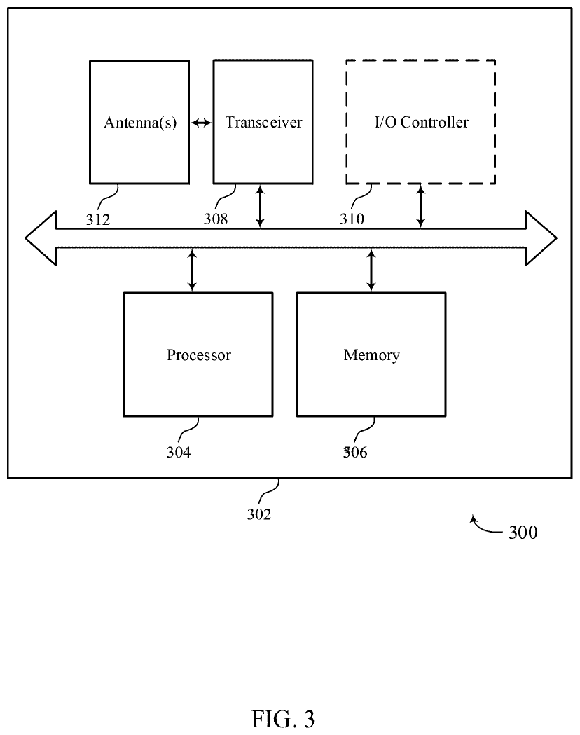

FIG. 3 illustrates an example of a block diagram 300 of a device 302 that supports XR communications in accordance with aspects of the present disclosure. The device 302 may be an example of a network entity 102 or UE 104 as described herein. The device 302 may support wireless communication with one or more network entities 102, UEs 104, or any combination thereof. The device 302 may include components for bi-directional communications including components for transmitting and receiving communications, such as a processor 304, a memory 306, a transceiver 308, and an I/O controller 310. These components may be in electronic communication or otherwise coupled (e.g., operatively, communicatively, functionally, electronically, electrically) via one or more interfaces (e.g., buses).

The processor 304, the memory 306, the transceiver 308, or various combinations thereof or various components thereof may be examples of means for performing various aspects of the present disclosure as described herein. For example, the processor 304, the memory 306, the transceiver 308, or various combinations or components thereof may support a method for performing one or more of the operations described herein.

In some implementations, the processor 304, the memory 306, the transceiver 308, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 304 and the memory 306 coupled with the processor 304 may be configured to perform one or more of the functions described herein (e.g., executing, by the processor 304, instructions stored in the memory 306).

For example, the processor 304 may support wireless communication at the device 302 in accordance with examples as disclosed herein. The processor 304 may be configured as or otherwise support a means for receiving, from a RAN, a configuration for reporting delay information for data of an LCG, triggering a DSR when delay information associated with the data of the LCG satisfies a condition, and transmitting the DSR in a PUSCH transmission to the RAN.

As another example, the processor 304 may support wireless communication at the device 302 in accordance with examples as disclosed herein. The processor 304 may be configured as or otherwise support a means for determining that new data has arrived to one or more LCGs associated with the UE, and transmitting a BSR MAC CE that comprises buffer size fields, wherein each buffer size field indicates a buffer size value using a BSR table for each LCG of the one or more LCGs.

The processor 304 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 304 may be configured to operate a memory array using a memory controller. In some other implementations, a memory controller may be integrated into the processor 304. The processor 304 may be configured to execute computer-readable instructions stored in a memory (e.g., the memory 306) to cause the device 302 to perform various functions of the present disclosure.

The memory 306 may include random access memory (RAM) and read-only memory (ROM). The memory 306 may store computer-readable, computer-executable code including instructions that, when executed by the processor 304 cause the device 302 to perform various functions described herein. The code may be stored in a non-transitory computer-readable medium such as system memory or another type of memory. In some implementations, the code may not be directly executable by the processor 304 but may cause a computer (e.g., when compiled and executed) to perform functions described herein. In some implementations, the memory 306 may include, among other things, a basic I/O system (BIOS) which may control basic hardware or software operation such as the interaction with peripheral components or devices.

The I/O controller 310 may manage input and output signals for the device 302. The I/O controller 310 may also manage peripherals not integrated into the device M02. In some implementations, the I/O controller 310 may represent a physical connection or port to an external peripheral. In some implementations, the I/O controller 310 may utilize an operating system such as iOS®, ANDROID®, MS-DOS®, MS-WINDOWS®, OS/2®, UNIX®, LINUX®, or another known operating system. In some implementations, the I/O controller 310 may be implemented as part of a processor, such as the processor M06. In some implementations, a user may interact with the device 302 via the I/O controller 310 or via hardware components controlled by the I/O controller 310.

In some implementations, the device 302 may include a single antenna 312. However, in some other implementations, the device 302 may have more than one antenna 312 (i.e., multiple antennas), including multiple antenna panels or antenna arrays, which may be capable of concurrently transmitting or receiving multiple wireless transmissions. The transceiver 308 may communicate bi-directionally, via the one or more antennas 312, wired, or wireless links as described herein. For example, the transceiver 308 may represent a wireless transceiver and may communicate bi-directionally with another wireless transceiver. The transceiver 308 may also include a modem to modulate the packets, to provide the modulated packets to one or more antennas 312 for transmission, and to demodulate packets received from the one or more antennas 312.

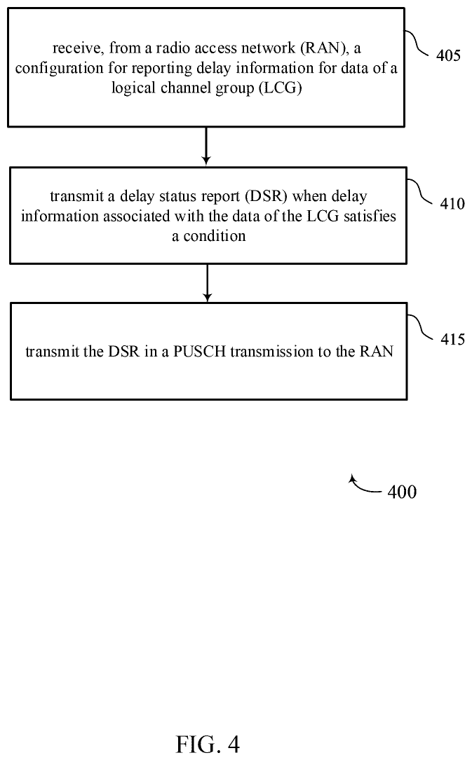

FIG. 4 illustrates a flowchart of a method 400 that supports transmitting a scheduling request based on an applied configuration in accordance with aspects of the present disclosure. The operations of the method 400 may be implemented by a device or its components as described herein. For example, the operations of the method 400 may be performed by the UE 104 as described with reference to FIG. 1. In some implementations, the device may execute a set of instructions to control the function elements of the device to perform the described functions. Additionally, or alternatively, the device may perform aspects of the described functions using special-purpose hardware.

At 405, the method 400 may include receiving, from a RAN, a configuration for reporting delay information for data of an LCG. The operations of 405 may be performed in accordance with examples as described herein. In some implementations, aspects of the operations of 405 may be performed by a device as described with reference to FIG. 1.

At 410, the method 400 may include triggering a delay status report (DSR) when delay information associated with the data of the LCG satisfies a condition. The operations of 410 may be performed in accordance with examples as described herein. In some implementations, aspects of the operations of 410 may be performed by a device as described with reference to FIG. 1.

At 415, the method 400 may include transmitting the DSR in a PUSCH transmission to the RAN. The operations of 415 may be performed in accordance with examples as described herein. In some implementations, aspects of the operations of 415 may be performed by a device as described with reference to FIG. 1.

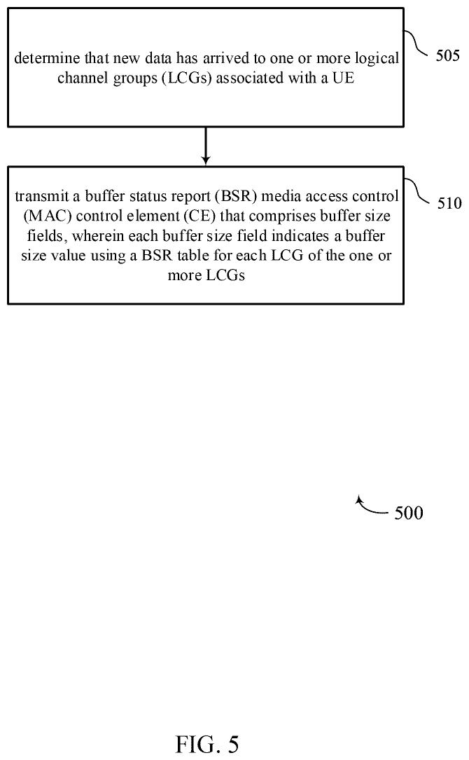

FIG. 5 illustrates a flowchart of a method that supports transmitting a BSR in accordance with aspects of the present disclosure. The operations of the method 500 may be implemented by a device or its components as described herein. For example, the operations of the method 500 may be performed by the UE 104 as described with reference to FIG. 1. In some implementations, the device may execute a set of instructions to control the function elements of the device to perform the described functions. Additionally, or alternatively, the device may perform aspects of the described functions using special-purpose hardware.

At 505, the method 500 may include determining that new data has arrived to one or more logical channel groups (LCGs) associated with the UE. The operations of 505 may be performed in accordance with examples as described herein. In some implementations, aspects of the operations of 505 may be performed by a device as described with reference to FIG. 1.

At 510, the method 500 may include transmitting a BSR media access control MAC CE that comprises buffer size fields, wherein each buffer size field indicates a buffer size value using a BSR table for each LCG of the one or more LCGs. The operations of 510 may be performed in accordance with examples as described herein. In some implementations, aspects of the operations of 510 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE), comprising:
at least one memory; and
at least one processor coupled with the at least one memory and configured to cause the UE to:
receive, from a radio access network (RAN), a configuration for reporting delay information for data of a logical channel group (LCG);
trigger a delay status report (DSR) when delay information associated with the data of the LCG satisfies a condition; and
transmit the DSR in a physical uplink shared channel (PUSCH) transmission to the RAN.

2. The UE of claim 1, wherein the delay information comprises a remaining time associated with the data of the LCG.

3. The UE of claim 2, wherein the delay information is associated with a packet data unit (PDU) set of the LCG.

4. The UE of claim 1, wherein the DSR is triggered in response to a remaining delay of a packet data unit (PDU) set of the LCG being under a configured threshold.

5. The UE of claim 1, wherein the DSR includes delay information and buffer size information for the LCG.

6. The UE of claim 1, wherein the DSR is part of a media access control (MAC) control element (CE).

7. The UE of claim 6, wherein the DSR includes, in the MAC CE, buffer size information that comprises an amount of data for all packet data convergence protocol (PDCP) packet data units (PDUs) or service data units (SDUs) of a PDU set of which at least one PDCP SDU has a remaining delay that is under a configured delay threshold.

8. The UE of claim 6, wherein a field or identifier of the MAC CE indicates a buffer size table used for buffer size information.

9. The UE of claim 1, wherein the delay information represents a shortest remaining value of a packet data convergence protocol (PDCP) discardTimer among PDCP service data units (SDUs) buffered for the LCG at a first symbol of a PUSCH transmission that includes the DSR.

10. The UE of claim 1, wherein the at least one processor is further configured to cause the UE to:
cancel a pending DSR in response to transmission of a media access control (MAC) protocol data unit (PDU) that includes a MAC control element (CE) containing the delay information.

11. The UE of claim 1, wherein the configuration received from the RAN comprises a set of scheduling request configurations for the LCG, including:
a first scheduling request configuration associated with triggering the DSR when new data arrives to the LCG; and
a second scheduling request configuration associated with triggering the DSR when the delay information associated with the data of the LCG satisfies the condition.

12. A method performed by a user equipment (UE), the method comprising:
receiving, from a radio access network (RAN), a configuration for reporting delay information for data of a logical channel group (LCG);
triggering a delay status report (DSR) when delay information associated with the data of the LCG satisfies a condition; and
transmitting the DSR in a physical uplink shared channel (PUSCH) transmission to the RAN.

13. The method of claim 12,
wherein the configuration received from the RAN comprises a set of scheduling request configurations for the LCG, including:
a first scheduling request configuration associated with triggering the DSR when new data arrives to the LCG; and
a second scheduling request configuration associated with triggering the DSR when the delay information associated with the data of the LCG satisfies the condition.

14. (canceled)

15. (canceled)

16. The method of claim 12, wherein the DSR is triggered in response to a remaining delay of a packet data unit (PDU) set of the LCG being under a configured threshold.

17. A processor for wireless communication, the processor comprising:
at least one controller coupled with at least one memory and configured to cause the processor to:
receive, from a radio access network (RAN), a configuration for reporting delay information for data of a logical channel group (LCG);
trigger a delay status report (DSR) when delay information associated with the data of the LCG satisfies a condition; and
transmit the DSR in a physical uplink shared channel (PUSCH) transmission to the RAN.

18. A user equipment (UE), comprising:
at least one memory; and
at least one processor coupled with the at least one memory and configured to cause the UE to:
determine that new data has arrived to one or more logical channel groups (LCGs) associated with the UE; and
transmit a buffer status report (BSR) media access control (MAC) control element (CE) that comprises buffer size fields,
wherein each buffer size field indicates a buffer size value using a BSR table for each LCG of the one or more LCGs.

19. The UE of claim 18, wherein at least one BSR table indicates a data volume for the data of the one or more LCGs.

20. The UE of claim 18, wherein the BSR MAC CE is identified by a logical channel ID (LCH ID) reserved for the BSR MAC CE.

21. The UE of claim 1, wherein the delay information is part of a media access control (MAC) control element (CE) and indicates a status of a remaining time associated with the data of the LCG at a time of transmission of the MAC CE.

22. The UE of claim 1, wherein the configuration indicates whether to include delay information associated with the data of the LCG or a logical channel (LCH) within the DSR.
